(19) United States
(12) Patent Application Publication
(10) Pub. No.: US 2017/0171737 A1
(43) Pub. Date: Jun. 15, 2017

(54) METHOD IN A WIRELESS COMMUNICATION NETWORK FOR NOTIFYING A COMMUNICATION DEVICE THAT CONTEXT STORING IS EMPLOYED IN THE NETWORK

(71) Applicant: Telefonaktiebolaget LM Ericsson (publ), Stockholm (SE)

(72) Inventors: Filip MESTANOV, Sollentuna (SE); Guido Roland HIERTZ, Aachen (DE); Christofer LINDHEIMER, Linköping (SE); Leif WILHELMSSON, Dalby (SE)

(21) Appl. No.: 15/327,276

(22) PCT Filed: Apr. 7, 2015
(86) PCT No.: PCT/SE2015/050415

§ 371 Date: Jan. 18, 2017

Related U.S. Application Data
(60) Provisional application No. 62/042,418, filed on Aug. 27, 2014.

(51) Int. Cl. H04W 8/16; H04W 76/02; H04L 29/06; H04W 48/10; H04W 12/06; H04W 8/26; H04L 29/12

(52) U.S. Cl. CPC H04W 8/16; H04W 8/26; H04W 76/021; H04L 61/2092; H04W 48/10; H04W 12/06; H04L 63/0876; H04L 61/6022; H04W 84/12

(57) ABSTRACT

A communication device and a method therein for use in a connection with a first network node. The communication device and the first network node are operating in a WLAN. The method comprises receiving a notification from the first network node, which notification comprises information relating to whether or not the first network node is configured to apply context storing or relating to whether or not the first network node is configured to associate a first MAC address with stored context. The method further comprises determining a second MAC address based on the received notification; and applying the second MAC address in a connection with the first network node.

### TECHNICAL FIELD

Embodiments herein relate generally to a network node and a communication device, and to methods therein. In particular they relate to the transmission and reception of information relating to context storing.

### BACKGROUND

Communication devices such as terminals are also known as e.g. User Equipments (UE), mobile terminals, stations (STAs), wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base 30 station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE controlled by the radio base station.

In Wireless Local Area Network (WLAN) technology, the Medium Access Control (MAC) address of a station (STA), e.g. a communication device such as a mobile device, is a unique identifier that is assigned to the wireless network interface. The MAC address has a length of 6 bytes, organized as illustrated in FIG. 1.

The STA's MAC address is exposed every time a STA decides to transmit a frame, e.g. a radio frame, to a receiving node, e.g. a WLAN Network node such as an Access Point (AP) or an Access Controller (AC). In that sense, the WLAN network node may obtain the MAC address of the STA after the very first frame it receives from the STA.

Up until recently, the MAC address associated to a particular mobile device was kept unchanged. However, recent events have shown that in some situations, using the same MAC address could compromise privacy and allow for user location tracking. In order to solve this problem, some mobile device vendors have come up with mechanisms that allow the mobile device to randomize its MAC address every time it has to open a new connection and by doing so preventing user location tracking.

### SUMMARY

An object of embodiments herein is to provide a way of improving the performance in a wireless communications network.

According to a first aspect of embodiments herein, the object is achieved by a method in a communication device for use in a connection with a first network node. The communication device and the first network node are operating in a Wireless Local Area Network (WLAN).

The communication device receives a notification from the first network node, which notification comprises information relating to whether or not the first network node is configured to apply context storing or relating to whether or not the network node is configured to associate a first Medium Access Control (MAC) address with stored context.

Further, the communication device determines a second MAC address based on the received notification; and applies the second MAC address in a connection with the first network node.

According to a second aspect of embodiments herein, the object is achieved by a communication device for use in a connection with a first network node. The communication device and the first network node are operating in a Wireless Local Area Network (WLAN).

The communication device is configured to receive a notification from the first network node, which notification comprises information relating to whether or not the first network node is configured to apply context storing or relating to whether or not the first network node is configured to associate a first Medium Access Control (MAC) address with stored context.

Further, the communications device is configured to determine a second MAC address based on the received notification and to apply the second MAC address in a connection with the first network node.

According to a third aspect of embodiments herein, the object is achieved by a method in a first network node for assisting a communication device in a connection with the first network node. The first network node and the communication device are operating in a Wireless Local Area Network (WLAN).

The first network node transmits a notification to the communication device, which notification comprises information relating to whether or not the first network node is configured to apply context storing or relating to whether or not the first network node is configured to associate a first Medium Access Control (MAC) address with stored context.

According to a fourth aspect of embodiments herein, the object is achieved by a first network node for assisting a communication device in a connection with the first network node. The first network node and the communication device are operating in a Wireless Local Area Network (WLAN).

The first network node is configured to transmit a notification to the communication device, which notification comprises information relating to whether or not the first network node is configured to apply context storing or relating to whether or not the first network node is configured to associate a first Medium Access Control (MAC) address with stored context.

Since a notification is transmitted from the first network node to the communication device and since the notification comprises information relating to whether or not the first network node is configured to apply context storing or relating to whether or not the network node is configured to associate a first Medium Access Control (MAC) address with stored context, the communication device may determine a MAC address to be used in a connection with the first network node based on the received notification. Thereby, the communication device may determine to use a MAC address for which context storing is applied in order to improve user experience. However, in other cases the communication device may determine to use a MAC address for which context storing is not applied in order to prevent user tracking and benefit from increased privacy.

### BRIEF DESCRIPTION OF DRAWINGS

Examples of embodiments herein are described in more detail with reference to attached drawings in which:

FIG. 1 schematically illustrates the configuration of the MAC address;

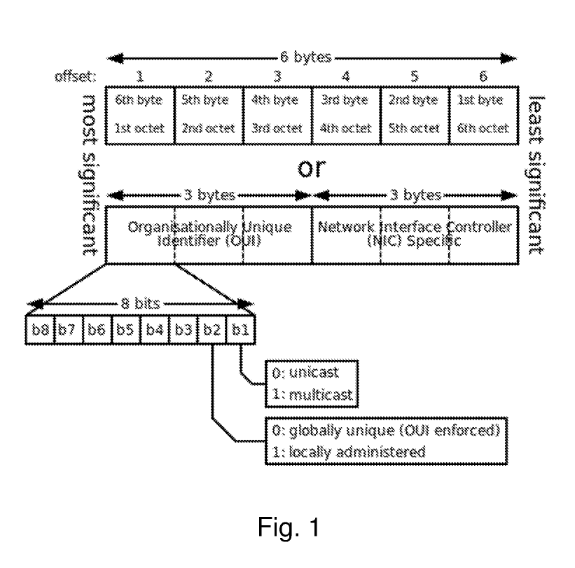

FIG. 2 schematically illustrates an embodiment of a communication system;

FIG. 3 is a flowchart depicting embodiments of a method in a first network node; and

FIG. 4 is a flowchart depicting embodiments of a method in a communication device

FIG. 5 is a flowchart depicting embodiments of a method in a network node;

FIG. 6 is a flowchart depicting embodiments of a method in a communication device;

FIG. 7 schematically illustrates the architecture of an embodiment of a communication system;

FIG. 8 is a schematic block diagram of embodiments of a network node; and

FIG. 9 is a schematic block diagram of embodiments of a communication device.

### DETAILED DESCRIPTION

As part of developing embodiments herein, a problem will first be identified and discussed.

There exist many situations when an Access Point (AP), e.g. a WLAN AP, would benefit from a communication device, e.g. a STA, using the same MAC address every time it connects to a certain AP. For example, in many cases an AP would store information on previously connected STAs in order to improve the user experience during consecutive connections. The information type that the AP may store depends on the scenario, but it may comprise user preferences, STA specific settings at the AP, etc. Furthermore, in scenarios where the WLAN system is integrated with a cellular communications system, the STA MAC address is used to link the WLAN information with the respective cellular information.

It becomes apparent that in some situations, the STA will need to use its permanent MAC address in order to enable smart network functionality, while in other situations it will need to change its MAC address to prevent user tracking.

Further, with increasing adoption of WLAN devices, herein also sometimes referred to as Wi-Fi devices, privacy concerns associated with the technology have become more and more apparent. Wi-Fi devices tend to use the same identifier, e.g., MAC address, when connecting to different communications networks and this identifier does not change over time. However, some Wi-Fi device vendors have lately adopted measures in order to improve user privacy by periodically changing the MAC address of the device. One such example is Apple's iOS 8 feature for MAC address randomization every time a new connection is initiated.

While this feature does provide an increased privacy in some cases, it could lead to degradation in user experience in other cases. Some communications networks require the STA to use the same identifier every time it connects in order to fetch previously stored information associated with that device, e.g. the device's or user's context.

A problem with the state of the art solutions is that there is no differentiation between the case when the communication network does not have a stored context for the mobile device and the case when it does. Therefore, when a mobile device connects to a certain communications network it cannot make use of this differentiation.

Therefore, an object of embodiments herein is to provide a way of improving the performance in the communications network.

Embodiments herein provide a method by which a communications network, e.g. a WLAN, notifies a communication device, e.g. a WLAN device, whether or not it employs context storing. In that way, when the communication device connects to the communications network it knows if this particular network stores context for its users and hence the communication device knows if it should use the same identity when reconnecting to the network in the future.

The entire collection of information and preferences that pertains to a particular communication device, such as a particular STA, and e.g. a user, or parts thereof is herein referred to as context. Thus, the context may relate to the entire collection of information and preferences that pertains to the particular communication device or user, or the context may relate to parts of the collection of information and preferences that pertains to the particular STA or user.

If the communications network did not notify the communication device that it employs context storing, the communication device would use a different identity every time it connects to the communications network and hence requires the network to generate the context at every connection.

Terminologies

The following commonly terminologies are used in embodiments and are elaborated below:

Radio network node: In some embodiments, the non-limiting term radio network node is more commonly used and it refers to any type of network node serving UE and/or connected to other network node or network element or any radio node from where UE receives signal. Examples of radio network nodes are Node B, base station (BS), multi-standard radio (MSR) radio node such as MSR BS, eNode B, network controller, radio network controller (RNC), base station controller, relay, donor node controlling relay, base transceiver station (BTS), access point (AP), transmission points, transmission nodes, Remote Radio Unit (RRU), Remote Radio Head (RRH), nodes in distributed antenna system (DAS) etc.

Network node: In some embodiments, a more general term “network node” is used and it may correspond to any type of radio network node or any network node, which communicates with at least a radio network node. Examples of network node are any radio network node stated above, core network node (e.g. Mobile Switching Center (MSC), Mobile Mobility Entity (MME), etc), Operation & Maintenance (O&M), Operations Support System (OSS), Self-Organizing Network (SON), positioning node (e.g. Enhanced Serving Mobile Location Centre (E-SMLC)), Minimization of Drive Tests (MDT) etc.

User equipment: In some embodiments, the non-limiting term user equipment (UE) is used and it refers to any type of wireless device, e.g. communication device, communicating with a network node in a communication system. Examples of UE are target device, device to device UE, machine type UE or UE capable of machine to machine communication, PDA, iPAD, Tablet, mobile terminals, smart phone, laptop embedded equipped (LEE), laptop mounted equipment (LME), USB dongles etc.

Note that although terminology from 3GPP LTE has been used in this disclosure to exemplify the embodiments herein, this should not be seen as limiting the scope of the embodiments herein to only the aforementioned system. Other wireless systems, including WCDMA, WiMax, Ultra Mobile Broadband (UMB) and GSM, may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” as device 2, and these two devices communicate with each other over some radio channel. It should be understood that even if wireless transmissions in the downlink is described, embodiments herein are equally applicable in the uplink.

In this section, the embodiments herein will be illustrated in more detail by a number of exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

Throughout this description, a WLAN and a 3GPP network are used as example networks for illustrative purposes only, the general idea of all embodiments are applicable to steering between a cellular network, such as a 3GPP network, and other non-cellular network, such as other non-3GPP networks, based on technologies other than WLAN.

However, it should be understood that embodiments herein may comprise only a non-cellular network, e.g. embodiments herein may comprise only the WLAN 101. This means that embodiments herein may comprise an AP and a STA, which AP is further connected to the Internet.

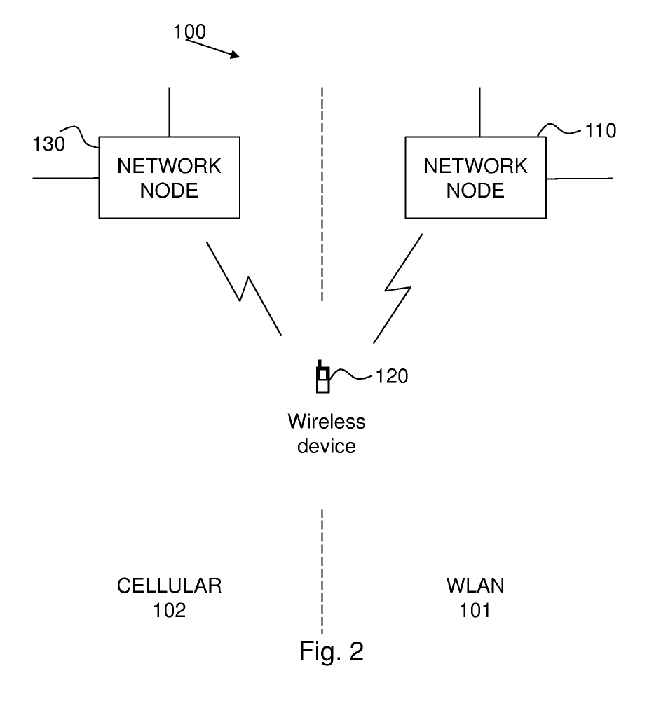

In FIG. 2, a schematic communications system 100 is illustrated. The communications system 100 comprises a first communications network, e.g. a first Radio Access Network (RAN), such as a non-cellular network, e.g. a WLAN 101. The communications system 100 may further comprise a second communications network, e.g. a second RAN, such as a cellular network 102, e.g. a 3GPP-nework.

The first communications network ,such as the WLAN 101, comprises a first network node 110, such as an Access Point (AP) or an Access Controller (AC), such as a WLAN AP or a WLAN AC. However, the first network node 110 may also be an access point that may be integrated with other functionality, but that holds the WLAN MAC and PHY protocols for communication with the communication device 120.

Further, the communications system 100 comprises a communication device 120, such as a station (STA). Reference is herein sometimes made to the communication device such as the mobile device. However, it should be understood that the communication device may refer to any device equipped with or comprising a wireless network interface. Thus, the communication device may refer to a fixed device, or stationary device, such as a desktop device or a workstation that is equipped with or comprises a wireless network interface.

The communication device 120 is capable of wireless communication in the first communications network, such as the WLAN 101, via the first network node 110. Further, the communication device 120 may be capable of cellular communication in the second RAN 102 via to second network node 130. Thus, the communication device 120 may be a multi-mode device. However, it should be understood that the communication device 120 may be a single-mode device, such as a Wi-Fi-only device.

The communication device 120 may be located within one or more geographical area, sometimes referred to as a cell, and is served by the second network node 130. Furthermore, the communication device 120 transmits data over a radio interface to the second network node 130 in an uplink (UL) transmission and the second network node 130 transmits data to the communication device 120 in a downlink (DL) transmission.

In some embodiments, the second communications network 102 comprises the second network node 130.

The second network node 130 may be a base station such as an eNB, an 35 eNodeB, Node B or a Home Node B, a Home eNode B, a radio network controller, a base station controller, an access point, a relay node which may be fixed or movable, a donor node serving a relay, a GSM/EDGE radio base station, a Multi-Standard Radio (MSR) base station or any other network unit capable to serve a wireless device or another radio network node comprised in the second network 102.

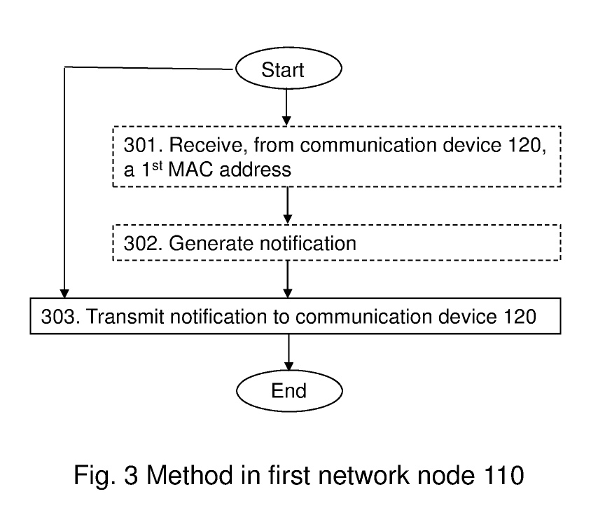

A method in the first network node 110 for assisting the communication device 120 in a connection with the first network node 110 will now be described with reference to FIG. 3. As mentioned above, the first network node 110 and the communication device 120 are operating in the WLAN 101.

The method comprises one or more of the following actions. It should be understood that some actions are optional, that actions may be taken in another suitable order and that actions may be combined.

Action 301

In some embodiments, the first network node 110 receives, from the communication device 120, the first MAC address in an Association Request, an Authentication Request or a Probe Request. The communication device 120 may transmit the first MAC address to the first network node 110 when the communication device 120 wants to know whether or not the first MAC address has been or is to be stored by the network node 110. This may for example be the case when the first network node 110 previously has stored and associated the first MAC address with stored context or when the first network node 110 is to store and associate the first MAC address with stored context.

Action 302

As will be described in Action 303 below, the network node 110 transmits a notification to the communication device 120 in order to transmit information relating to context storing. For example, the notification comprises information relating to whether or not the first network node 110 is configured to apply context storing or relating to whether or not the first network node 110 is configured to associate a first MAC address with stored context.

In some embodiments, the first network node 110 generates the notification as a single bit value comprised in a single bit field of an Information Element (IE).

However, it should be understood that in some embodiments, the notification comprises more information and in such embodiments the notification is comprised in several bit fields of for example the IE. This may for example be the case when the notification that is to be sent to the communication device 120 should not indicate whether context storing is employed by the first network node 110 or not. Instead the notification should indicate whether a particular MAC address, e.g. the first MAC address mentioned in Action 301 above, that has been used by the communication device 120 in an Association Request or Probe Request or similar, in fact has been or is going to be stored by the first network node 110.

Action 303

The first network node 110 transmits the notification to the communication device 120. The notification comprises information relating to whether or not the first network node 110 is configured to apply context storing or relating to whether or not the first network node 110 is configured to associate a first MAC address with stored context.

In some embodiments, the first network node 110 transmits the notification in an existing IE such as in an SSID element, in a new IE, and/or in a vendor specific element.

Further, the first network node 110 may transmit the notification in a broadcast signal or in a unicast signal.

The notification may be comprised in one or more Beacon frames, one or more

Probe Response frames, one or more Authentication Response frames, one or more Association Response frames, and/or in one or more WNM-Notification Response frames.

This Action relates to Action 501 which will be described below.

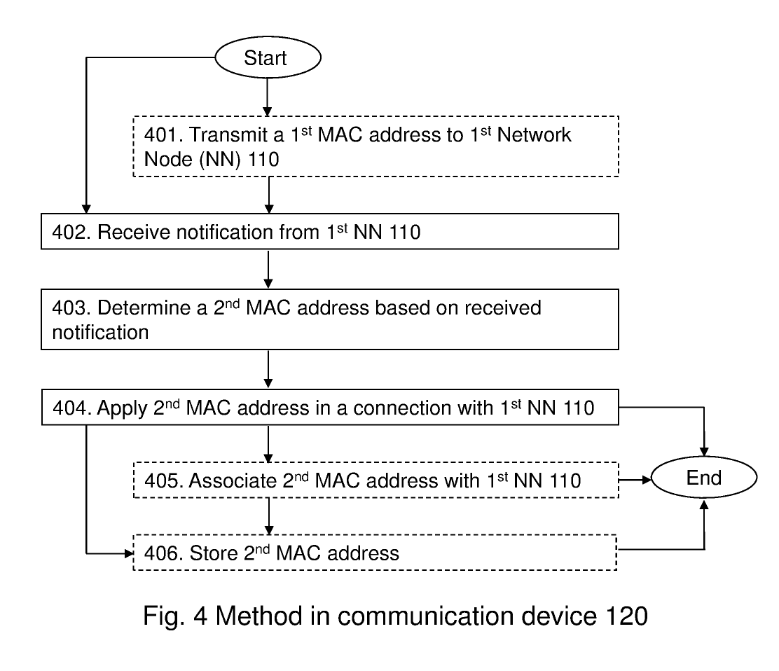

A method in the communication device 120 for use in a connection with the first network node 110 will now be described with reference to FIG. 4. As mentioned above, the first network node 110 and the communication device 120 are operating in the WLAN 101. The method comprises one or more of the following actions. It should be understood that some actions are optional, that actions may be taken in another suitable order and that actions may be combined.

Action 401

In some embodiments, the communication device 120 transmits a first MAC address to the first network node 110 in an Association Request, an Authentication Request or a Probe Request.

The communication device 120 may transmit the first MAC address to the network node 110 when the communication device 120 wants to know whether or not the first MAC address has been or is to be stored by the network node 110. This may for example be the case when the communication device 120 wants to know whether or not the network node 110 previously has stored and associated the first MAC address with stored context or whether or not the network node 110 is to store and associate the first MAC address with stored context.

Action 402

The communication device 120 receives a notification from the first network node 110. The notification comprises information relating to whether or not the network node 110 is configured to apply context storing or relating to whether or not the network node 110 is configured to associate the first MAC address with stored context.

The notification may be comprised in one or more Beacon frames, one or more Probe Response frames, one or more Authentication Response frames, one or more Association Response frames, and/or in one or more Wireless Network Management, WNM, Notification Response frames.

The communication device 120 may receive the notification in an existing IE, such as in an SSID element, in a new IE, and/or in a vendor specific element. Further, the communication device 120 may receive the notification in a broadcast signal or in a unicast signal.

This Action relates to Action 601 which will be described below.

Action 403

In some embodiments, the communication device 120 determines a second MAC address based on the received notification.

For example, this may be the case when the communication device 120 or the user of the communication device 120 wants to benefit from the usage of context storing and the communication device 120 has been notified that context storing is not applied for the first MAC address and in such case the communication device 120 may determine the second MAC address as a MAC address for which context storing is applied.

However, in other cases the communication device 120 or the user thereof wants to benefit from an improved user privacy. In such cases and if the communication device 120 has been notified that context storing is applied for the first MAC address, the communication device 120 may determine the second MAC address as a MAC address for which context storing is not applied.

In some embodiments, the second MAC address may be or correspond to the first MAC address.

The communication device 120 may determine the second MAC address as a permanent MAC address, a randomized MAC address, a network specific MAC address, or as a network node specific MAC address.

This Action relates to Action 602 which will be described below.

Action 404

The communication device 120 applies the second MAC address in a connection with the first network node 110. This Action relates to Actions 603 and/or 603′ which will be described below.

Action 405

In some embodiments, the communication device 120 associates the second MAC address with the first network node 110. Thereby, the second MAC address may be used in one or more subsequent connections with the same network node, whereby an improved user experience may be obtained.

Action 406

The communication device 120 may store the second MAC address as a MAC address to be used during a subsequent connection with the first network node 110. As previously mentioned, using the same MAC address at subsequently connections with the network node may improve the user experience.

In some embodiments, the first network node 110, such as the WLAN node, e.g. an Access Point (AP) or an Access Controller (AC), informs, i.e. notifies, one or more communications devices 120, such as the STAs, whether or not the network 101 employs context storing. The notification may be performed either via broadcast, e.g., in one or more Beacon frames, or via unicast signaling such as e.g., Probe, Association, Authentication response signaling (IEEE Standard for Information technology—Telecommunications and information exchange between systems, Local and metropolitan area networks—Specific requirements: Part 11: Wireless LAN Medium Access Control (MAC) and Physical Layer (PHY) Specifications, IEEE Std 802.11™-2012).

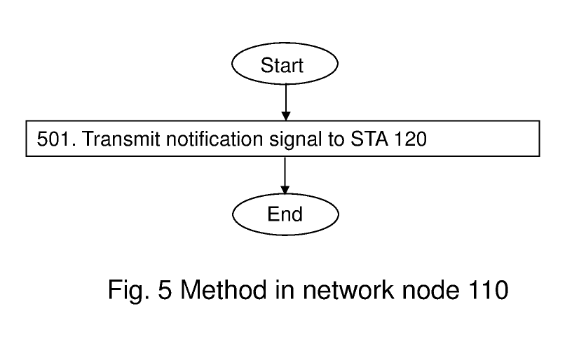

Thus, in some embodiments, the first network node 110, such as the WLAN node, transmits a signal, such as a notification signal or an indication signal, to the communications device 120, such as the STA, in order to, for example, inform the communications device 120, such as the STA, about whether or not the first network node 110, such as the WLAN node, employ contexts storing. This is schematically illustrated in FIG. 5 wherein the first network node 110 in Action 501 transmits a notification signal to the communications device 120. As mentioned above, Action 501 relates to Action 303 described above. Further, as also mentioned above, the notification signal may be a broadcast signal or a unicast signal. Further, in some embodiments described herein, the notification signal is also referred to as an indication signal.

Further, the notification may be implemented in several ways. For example, in some embodiments, the notification is comprised in one of the existing Information Elements (IE), for example in a Service Set Identifier (SSID) element. In some other embodiments, a new IE is introduced, which IE comprises or pertains to information related to context storing. Further, in some embodiments, the context storing information is included or comprised as a vendor specific element. It should be understood that in some embodiments, the notification is implemented as a combination of one or more of the ways mentioned above.

Furthermore, in some embodiments, the first network node 110, such as the AP, has several SSID's associated with it. In such embodiments, the AP transmits the notification signal when the communication device 120, such as the STA, connects to a specific SSID, whereas at the same time, the AP may have other SSID's where the notification signal on context storing is not sent to the STA.

In some embodiments, the unicast notification provided by the first network node 110, such as the AP, may be comprised in a unicast frame that is send from the AP to a particular communications device 120, such as a particular STA. The information may be comprised in one or more frames of type Probe Response, Authentication Response, Association Response frames, Wireless Network Management (WNM)-Notification response, etc. In some embodiments, this is implemented by introducing a new IE, by using a vendor specific IE, and/or by amending an existing IE.

In some embodiments, the context storing information is defined as a single bit field. For example, the values that the field may assume are:
“0”: Context storing is not employed at this AP
“1”: Context storing is employed at this A

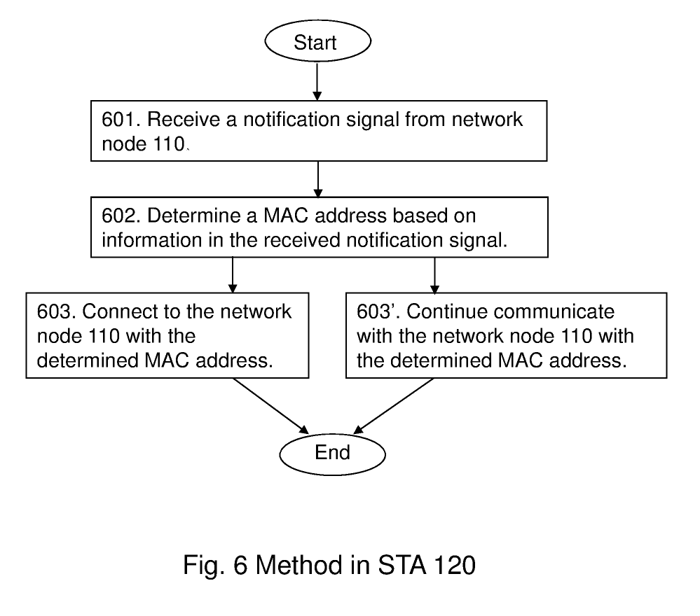

In some embodiments, the communications device 120, such as the STA, receives a notification, e.g. the notification signal mentioned above, from the first network node 110, such as the WLAN node. This is schematically illustrated in FIG. 6, wherein the STA in Action 601 receives a notification signal from the first network node 110. This action relates to Action 402 described above. The notification may be received either by means of e.g. broadcast signalling or unicast signalling. As mentioned, the notification relates to whether or not the first network node 110 applies context storing, whereby the STA may be configured to take this information into account during subsequent connections or during an ongoing connection to the same first communications network, such as the WLAN 101, e.g. to the first network node 110 transmitting the notification. One way the STA uses this information is for deciding whether or not a randomized MAC address maybe used when connecting to the WLAN 101.

Further, in some embodiments, after the STA has received information that a particular WLAN 101 uses context storing, it uses its permanent MAC address for subsequent connections to that WLAN 101. This relates to Action 602 of FIG. 6. As schematically illustrated in FIG. 6, in Action 602 the STA determines a MAC address based on information in the received notification, i.e. based on information in the notification received from the first network node 110. This action relates to Action 403 described above.

Furthermore, in some embodiments, the communications device 120, such as the STA, associates a particular MAC address (not necessarily its permanent MAC address) with each network, such as e.g. also the WLAN 101, that stores context information and uses said MAC address during subsequent connections to that same network, such as e.g. the WLAN 101. This also relates to Action 602. It should be understood that the particular MAC address may not be its permanent MAC address. This option requests or requires the STA to store multiple connection profiles for the different networks it connects to, but it also increases privacy since there is no need for the STA to revert to using its “permanent” MAC address every time it connects to a context storing network, such as e.g. the WLAN 101. In some embodiments, the particular MAC address is referred to as a network specific MAC address. Further, the particular MAC address may be a network node specific MAC address when the MAC address is specific for a specific network node of the network.

In yet some embodiments, the notification/indication comprised in the notification signal (also referred to as indication signal) that is sent to the STA does not indicate whether or not context storing is employed by the first network node 110, such as the AP. Instead, the notification indicates whether a particular MAC address, e.g., a MAC address that has been used by the STA in an Association Request or Probe Request or similar request in fact has been stored or is going to be stored. Thus, instead of addressing and saying something about operation in the AP, the indication says something about a particular MAC address and how this is treated in the AP or any other node in the network, e.g., an Access Controller (AC) in charge of multiple AP's. For example, if the STA is connecting to the AP, the AP may notify the STA that the MAC address that the STA is currently using is going to be associated with a certain stored context and this stored context will be used to assist the STA's operation within the whole or a part of the WLAN 101, e.g., across a plurality of APs. However, if in some situations, the AP does not wish to store the context for the STA, it might notify the STA that context storing for the MAC address is not to be employed, or it may send no notifications to the STA 120 at all.

The association request, also sometimes referred to as an association request frame, is sent from a STA to the AP and it enables the AP to allocate resources and synchronize. The frame may carry information about an interface controller, such as a Wireless Network Interface Controller (WNIC), and the information may relate to supported data rates and the SSID of the network the STA wishes to associate with. If the request is accepted, the AP reserves memory and establishes an association ID for the WNIC.

The probe request, also sometimes referred to as a probe request frame, is sent from a STA when it requires information from another station.

In some embodiments, the communications device 120, such as the STA, that receives a notification that its MAC address is associated to a certain context takes a decision whether or not to use that MAC address for subsequent connections or use a randomized address instead. In case it uses a randomized MAC address it is aware that it may not take advantage of optimizations supported by the network, such as e.g., faster transitions, steering between different networks, etc.

Thus, in some embodiments herein, the first network node 110, such as the AP, is configured to notify a communications device 120, such as an STA, that it employs context storing. Further, in some embodiments, the STA is configured to take appropriate action with regard to this notification. For example, it will always use the same MAC address when connecting to that AP.

In the description above it has been mentioned that the communications device 120, such as the STA, uses the determined MAC address when connecting to the first network node 110. However, it should be understood that an already connected STA may receive a notification signal from the first network node 110 to which it is connected. For example, this may be the case when the STA is connected to a first network node 110 that initially does not store any context, but due to e.g. the behavior of the traffic, a triggering of context storing may be accomplished. In such cases, the first network node 110 may send the notification signal to the connected STA. The connected STA may then determine a MAC Address, possibly a new MAC address, to be used in the further communication with the first network node 110 and to continue communicating with the first network node 110 with the determined MAC address. This relates to Actions 603 or 603′ of FIG. 6. As schematically illustrated in FIG. 6, in Action 603, the STA connects to the network node with the determined MAC address. In Action 603′, the STA has an ongoing communication with the first network node and thus continue communicating with the first network node with the determined MAC address. These actions relate to Action 404 described above.

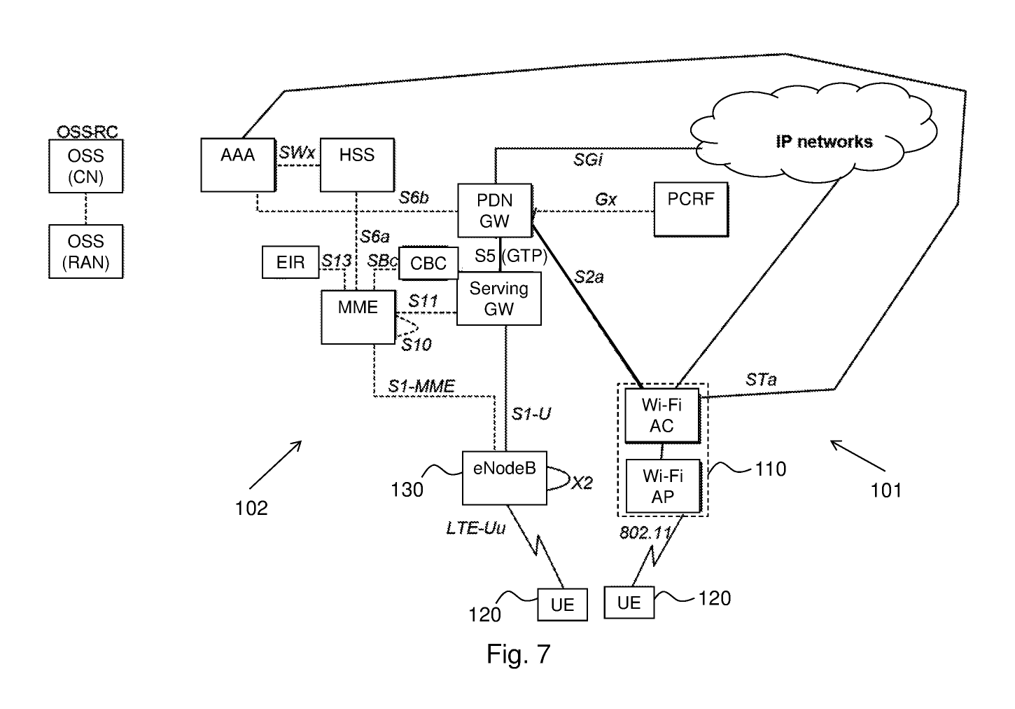

FIG. 7 shows schematically the network architecture for an Evolved Universal Terrestrial Radio Access Network (E-UTRAN) and an Evolved Packet Core (EPC) and how the eNodeB is connected via the S1-interfaces, S1-MME and S1-U to the MME and Serving gateway (GW), respectively. It also shows how the WLAN such as a Wi-Fi access network is connected to the Packet Data Network Gateway (PDN-GW) via the S2a interface and to the 3GPP Authentication, Authorization and Accounting (AAA) Server via the STa interface. It should be noted that the configuration of the Wi-Fi network shown in FIG. 7 is only an illustrative example and that the Wi-Fi network may be configured or arranged in several other ways and may comprise several further network nodes or entities. For example, the Wi-Fi network may also include a Broadband Network Gateway (BNG). In another example, the Wi-Fi AP may be co-located with a Residential Gateway (RG). In a further example, the Wi-Fi network may also comprise a Trusted WLAN Access Gateway (TWAG). In addition, the interface between the Wi-Fi AC and the PDN GW, i.e. the S2a interface, may also be implemented between the PDN GW and for example either the BNG or the RG.

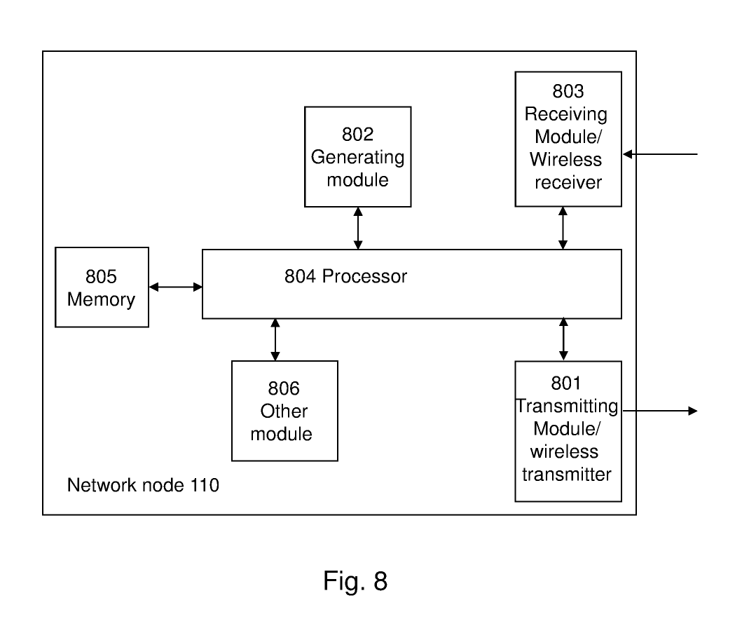

To perform the method for assisting the communication device 120 in a connection with the first network node 110, the first network node 110 may comprise an arrangement depicted in FIG. 8. As previously mentioned, the first network node 110 and the communication device 120 are operating in the WLAN 101.

In some embodiments, the first network node 110 comprises an input and/or output interface configured to communicate with one or more other network nodes, or one or more communications devices, such as the communication device 120. The input and/or output interface may comprise a receiving module and/or wireless receiver 803 and a transmitting module and/or wireless transmitter 801.

The first network node 110 is configured to transmit, e.g. by means of the transmitting module 801, the first MAC address to the first network node 110 in an Association Request, a Re-association Request, an Authentication Request or a Probe Request. The transmitting module 801 may be the wireless transmitter or a processor 804 of the first network node 110. The processor 804 will be described in more detail below.

The first network node 110 is configured to generate, e.g. by means of a generating module 802 configured to generate, the notification, e.g. the notification signal. The generating module 802 may be a processor 804 of the network node 110. The processor 804 will be described in more detail below.

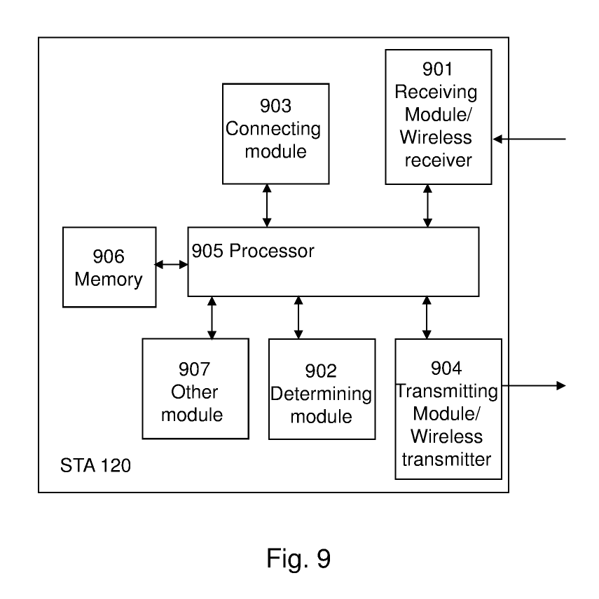

To perform the method for use in a connection with the first network node 110, the communication device 120 may comprise an arrangement depicted in FIG. 9. As previously mentioned, the first network node 110 and the communication device 120 are operating in the WLAN 101.

In some embodiments, the communication device 120 comprises an input and/or output interface configured to communicate with one or more other network nodes, such as the first network node 110 or the second network node 130, or one or more other communications devices. The input and/or output interface may comprise a receiving module and/or a wireless receiver 901 and a transmitting module and/or a wireless transmitter 904.

The communication device 120 is configured to receive, e.g. by a receiving module 901, the notification from the first network node 110.

The notification comprises information relating to whether or not the network node 110 is configured to apply context storing or relating to whether or not the network node 110 is configured to associate a first Medium Access Control (MAC) address with stored context.

The notification may be comprised in one or more Beacon frames, one or more Probe Response frames, one or more Authentication Response frames, one or more Association Response frames, and/or in one or more Wireless Network Management, WNM, Notification Response frames.

In some embodiments, the communication device 120 is configured to receive the notification in an existing Information Element, IE, such as in an SSID element, in a new IE, and/or in a vendor specific element.

Further, the communication device 120 may be configured to receive the notification in a broadcast signal or in a unicast signal.

Further, the communication device 120 is configured to determine, e.g. by a determining module 902, a second MAC address based on the received notification. The determining module 902 may be a processor 905 of the communication device 120. The processor 905 will be described in more detail below.

In some embodiments, the second MAC address is the first MAC address.

The communication device 120 may be configured to determine the second MAC address by being further configured to determine the second MAC address as a permanent MAC address, a randomized MAC address, a network specific MAC address, or as a network node specific MAC address.

The communication device 120 is further configured to apply, e.g. by a connecting module 903, the second MAC address in a connection with the first network node 110. The connecting module 903 may be the processor 905.

In some embodiments, the communication device 120 is configured to associate the second MAC address with the first network node 110, and to store the second MAC address as a MAC address to be used during a subsequent connection with the first network node 110.

The embodiments herein may be implemented through one or more processors, such as a processor in a network node, e.g. the processor 804 of the first network node 110, of the respective RANs and a processor in the communication device, e.g. the processor 905 of the communication device 120, together with computer program code for performing the functions and actions of the embodiments herein. The program code may be implemented in one or several network nodes both in the cellular network and/or in the non-cellular network and/or in the communication device (e.g. UE and/or STA). The program code mentioned above may also be provided as a computer program product, for instance in the form of a data carrier carrying computer program code for performing the embodiments herein when being loaded into network node or communication device. One such carrier may be in the form of a CD ROM disc. It is however feasible with other data carriers such as a memory stick. The computer program code may furthermore be provided as pure program code on a server and downloaded to the network node or the communication device.

A network node of the respective RAN and the communication device may further comprise a memory, e.g. the memories 805,906, comprising one or more memory units. The memory is arranged to be used to store obtained information, store data, configurations, schedulings, and applications etc. to perform the methods herein when being executed in the RAN or the communication device.

### Exemplifying Embodiments

Some embodiments herein relate to a first network node comprised in a first RAN, such as the network node 110 comprised in in the WLAN 101 as schematically illustrate in FIG. 2. The network node 110 is configured to transmit a notification signal to a communication device, such as the communication device 120 schematically illustrated in FIG. 2. This may be performed by means such as a transmitting module 801 comprised in the network node 110, cf. FIG. 8. The transmitting module 801 may be a wireless transmitter 401 comprised in the network node 110.

Further, the notification signal may be generated by means such as a generating module 802 comprised in the network node 110. The generating module 802 may be a processor 804 of the network node 110. The notification signal may comprise information relating to whether or not the network node 110 applies context storing. As previously mentioned the term context when used herein refers to the entire collection of information and preferences that relates to a particular communication device, and possible also to e.g. a particular user, or parts thereof. Thus, the context may relate to the entire collection of information and preferences that pertains to the particular STA or user, or the context may relate to parts of the collection of information and preferences that pertains to the particular STA or user.

Some embodiments herein relate to a method in the first network node 110, cf. FIGS. 3 and 5. The network node 110 transmits a notification signal to the communication device, such as the communication device 120 schematically illustrated in FIG. 2. As previously mentioned, the notification signal may comprise information relating to whether or not the network node 110 applies context storing.

Some embodiments herein relate to a communication device, such as communication device 120 in FIG. 2, having a first connection in a first RAN, such as WLAN 101 in FIG. 2. The communication device 120 is configured to receive a notification signal from the network node, such as the network node 110 in FIG. 2. This may be performed by means such as a receiving module 901 comprised in the communication device 120, cf. FIG. 9. The receiving module 901 may be a wireless receiver comprised in the communication device 120.

Further, based on the received notification signal, the communication device 120 is configured to determine a MAC address. This may be performed by means such as a determining module 902 comprised in the communication device 120. The determining module 902 may be a processor 605 of the communication device 120. The determined MAC address may be a random MAC address, a permanent Mac address, a network specific MAC address, or a network node specific MAC address.

The communication device 120 is furthermore configured to connect to the network node 110 with the determined MAC address. This may be performed by means such as a connecting module 903 comprised in the communication device 120. The connecting module 903 may be the processor 905.

Some embodiments herein relate to a method in the communication device 120, cf. FIGS. 4 and 6. The communication device 120 receives a notification signal from the network node, such as the network node 110 in FIG. 2. Further, based on the received notification signal, the communication device 120 determines a MAC address. Furthermore, the communication device 120 connects to the network node 110 with the determined MAC address.

It should be understood that in some embodiments described herein, the notification from the network node to the communication device regarding the context storing may be performed prior to the connection establishment, after the connection establishment as well as in an initial signalling before connection establishment.

Further, embodiments herein comprise one or more modules configured to realise features and to perform actions described herein.

### Advantages of Some Embodiments

Some embodiments disclosed herein provide for the communications network, e.g. the WLAN network, to store context for a mobile device, e.g. a WLAN device, and to make use of this context in subsequent or ongoing connections of the same WLAN device, by informing the WLAN device that context storing is employed in the communications network. The benefits of being able to store context, as opposed to generating a new one every time a device connects to the network, are manifold and comprise improvements in terms of user experience, e.g., shorter connection time, advanced functionality offerings, etc., and network performance, e.g., reduced overhead caused by excessive management signaling, more efficient use of radio resources, etc.

Those skilled in the art will also appreciate that embodiments herein comprises one or more modules to realize features and functions and to perform actions described herein. The modules may refer to a combination of analog and digital circuits, and/or one or more processors configured with software and/or firmware, e.g. stored in the memory, that when executed by the one or more processors such as the processors in the RAN, the network node and communication device perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a communication device for use in a connection with a first network node, the communication device and the first network node operating in a Wireless Local Area Network, WLAN, the method comprising:
receiving a notification from the first network node, which notification comprises information relating to one of whether or not the first network node is configured to apply context storing and whether the network node is configured to associate a first Medium Access Control, MAC, address with stored context;
determining a second MAC address based on the received notification; and
applying the second MAC address in a connection with the first network node.

2. The method of claim 1, further comprising:
transmitting the first MAC address to the first network node in one of an Association Request, an Authentication Request and a Probe Request.

3. The method of claim 1, wherein the second MAC address is the first MAC address.

4. The method of claim 1, wherein determining the second MAC address further comprises:
determining the second MAC address as one of a permanent MAC address, a randomized MAC address, a network specific MAC address, and a network node specific MAC address.

5. The method of claim 1, wherein receiving the notification further comprises:
receiving the notification in one of an existing Information Element, IE, in a new IE, and in a vendor specific element.

6. The method of claim 1, wherein receiving the notification further comprises:
receiving the notification in one of a broadcast signal and a unicast signal.

7. The method of claim 6, wherein the notification is comprised in at least one of:
at least one Beacon frame;
at least one Probe Response frame;
at least one Authentication Response frame;
at least one Association Response; and
at least one Wireless Network Management, WNM, Notification Response frame.

8. The method of claim 1, further comprising:
associating the second MAC address with the first network node; and
storing the second MAC address as a MAC address to be used during a subsequent connection with the first network node.

9. A method in a first network node for assisting a communication device in a connection with the first network node, the first network node and the communication device operating in a Wireless Local Area Network, WLAN, the method comprising:
transmitting a notification to the communication device, which notification comprises information relating to one of whether the first network node is configured to apply context storing and whether the network node is configured to associate a first Medium Access Control, MAC, address with stored context.

10. The method of claim 9, further comprising:
receiving, from the communication device, the first MAC address in one of an Association Request, an Authentication Request and a Probe Request.

11. The method of claim 9, further comprising:
generating the notification as a single bit value comprised in a single bit field of an Information Element, IE.

12. The method of claim 9, wherein transmitting the notification further comprises:
transmitting the notification in one of an existing Information Element, IE, in a new IE, and in a vendor specific element.

13. The method of claim 9, wherein transmitting the notification further comprises:
transmitting the notification in one of a broadcast signal and a unicast signal.

14. The method of claim 13, wherein the notification is comprised in at least one of:
at least one Beacon frame;
at least one Probe Response frame;
at least one Authentication Response frame;
at least one Association Response; and
at least one Wireless Network Management, WNM, Notification Response frame.

15. A communication device for use in a connection with a first network node, the communication device and the first network node operating in a Wireless Local Area Network, WLAN, the communication device being configured to:
receive a notification from the first network node, which notification comprises information relating to one of whether the first network node is configured to apply context storing and whether or not the network node is configured to associate a first Medium Access Control, MAC, address with stored context;
determine a second MAC address based on the received notification; and
apply the second MAC address in a connection with the first network node.

16. The communication device of claim 15, further being configured to:
transmit the first MAC address to the first network node in one of an Association Request, an Authentication Request and a Probe Request.

17. The communication device claim 15, wherein the second MAC address is the first MAC address.

18. The communication device of claim 15, wherein the communication device is configured to determine the second MAC address by being further configured to:
determine the second MAC address as one of a permanent MAC address, a randomized MAC address, a network specific MAC address, and a network node specific MAC address.

19. The communication device claim 15, wherein the communication device is configured to receive the notification by being further configured to:
receive the notification in one of an existing Information Element, IE, in a new IE, and in a vendor specific element.

20. The communication device claim 15, wherein the communication device is configured to receive the notification by being further configured to:
receive the notification in one of a broadcast signal and a unicast signal.

21. The communication device of claim 20, wherein the notification is comprised in at least one of:
at least one Beacon frame;
at least one Probe Response frame;
at least one Authentication Response frame;
at least one Association Response; and
at least one Wireless Network Management, WNM, Notification Response frame.

22. The communication device claim 15, wherein the communication device is configured to:
associate the second MAC address with the first network node; and
store the second MAC address as a MAC address to be used during a subsequent connection with the first network node.

23. A first network node for assisting a communication device in a connection with the first network node, the first network node and the communication device operating in a Wireless Local Area Network, WLAN, the first network node is being configured to:
transmit a notification to the communication device, which notification comprises information relating to one of whether or not the first network node is configured to apply context storing and whether or not the network node is configured to associate a first Medium Access Control, MAC, address with stored context.

24. The first network node of claim 23, wherein the first network node is further configured to:
receive, from the communication device the first MAC address in one of an Association Request, an Authentication Request and a Probe Request.

25. The first network node of claim 23, wherein the first network node is further configured to:
generate the notification as a single bit value comprised in a single bit field of an Information Element, IE.

26. The first network node of claim 23, wherein the first network node is configured to transmit the notification by being further configured to:
transmit the notification in one of an existing Information Element, IE, in a new IE, and in a vendor specific element as in a Service Set Identifier, SSID, element, in a new IE, and/or in a vendor specific element.

27. The first network node of claim 23, wherein the first network node is configured to transmit the notification by being further configured to:
transmit the notification in one of a broadcast signal and a unicast signal.

28. The first network node of claim 27, wherein the notification is comprised in at least one of:
at least one Beacon frame;
at least one Probe Response frame;
at least one Authentication Response frame;
at least one Association Response; and
at least one Wireless Network Management, WNM, Notification Response frame.
